(19) United States
(12) Patent Application Publication
(10) Pub. No.: US 2008/0018133 A1
(43) Pub. Date: Jan. 24, 2008

(54) Spoiler accessory for a car

(75) Inventor: Kuo-Hsing Lin, Changhua County (TW)

Correspondence Address: EGBERT LAW OFFICES, 412 MAIN STREET, 7TH FLOOR, HOUSTON, TX, 77002, US

(73) Assignee: KENG LIEN INDUSTRIAL CO., LTD., Taichung City (TW)

(21) Appl. No.: 11/491,652

(22) Filed: Jul. 24, 2006

(51) Int. Cl. B62D 35/00

(52) U.S. Cl. 296/180.1

(57) ABSTRACT

The spoiler accessory for a car includes a spoiler body, which is a long plate. Two ends are on the spoiler body to be installed on the car, and an oblique rear wing is placed on one side of the spoiler body. There is a luminous body that is electroluminescent or LED. The luminous body is placed on the predetermined part of the spoiler body to achieve a warning effect, using the combination of the luminous body on the spoiler body.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to a spoiler accessory for a car, and more particularly to a structure with a luminous body thereon.

### BACKGROUND OF THE INVENTION

A spoiler for a vehicle is an auxiliary product or accessory for cars. It is usually added onto the trunk lid or onto the hood, and it creates a certain degree of absorbing or dissipating effects with regard to air flow and resistance.

With new developments in the industry, a luminous body is added to the conventional spoiler accessory to create a warning effect as an installation device. The structure of the luminous component added on the spoiler is usually placed inside the hollow space formed inside the spoiler, so that the light of the luminous component shines through the external part. With this conventional structure, the deflector must be made thicker because it has to fill the space inside, increasing size and weight thereof. More burden is added on the structure of the car. Moreover, in order to fill the space mentioned herein, the manufacturing process of the spoiler becomes more complicated by increasing the cost. The conventional spoiler does not meet the preferred practicability for the industry; moreover, the luminous body is not applicable for the thinner-size spoiler.

Thus, to overcome the aforementioned problems of the prior art, it would be an advancement in the art to provide an improved structure that can significantly improve efficacy.

To this end, the inventor has provided the present invention of practicability after deliberate design and evaluation based on years of experience in the production, development and design of related products.

### BRIEF SUMMARY OF THE INVENTION

The present invention primarily provides a luminous body 40 on the structure of the spoiler body 10. The spoiler body 10 eliminates the conventional need for space inside the spoiler body mentioned in the prior art, reducing the size, weight, and cost for the spoiler accessory. A warning and decorative effect is created, and the diversified demands of the consumer are satisfied.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a perspective view of the first embodiment of the present invention.

FIG. 2 shows a sectional view of the first embodiment of the present invention.

FIG. 3 shows a perspective view of the second embodiment of the present invention.

FIG. 4 shows another sectional view of the second embodiment of the present invention.

FIG. 5 shows a rear elevation view of the third embodiment of the present invention.

FIG. 6 shows a sectional view of the third embodiment of the present invention.

FIG. 7 shows another rear elevation view of the fourth embodiment of the present invention.

FIG. 8 shows a partial perspective view of the fifth embodiment of the present invention.

FIG. 9 shows another partial perspective view of the sixth embodiment of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

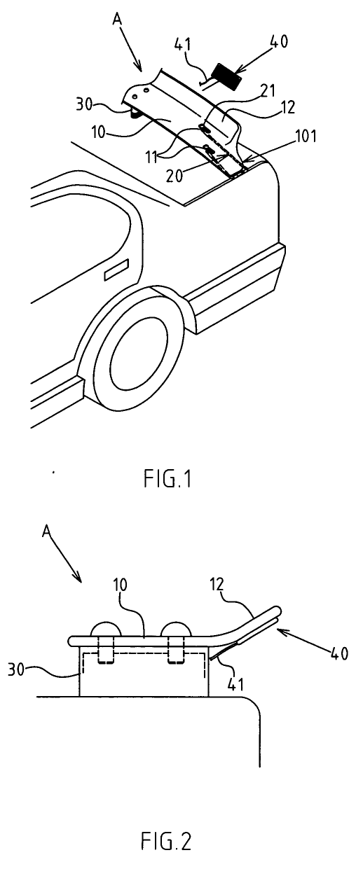

As shown in FIGS. 1, 2, 3, there is the preferred embodiment of the improved structure of a spoiler accessory for a vehicle. This preferred embodiment is for description only. The scope of the invention is determined by the claims and not the description.

The structure of spoiler accessory A includes a spoiler body 10, which is a long plate. There are two ends, each having a connecting part 101 for the spoiler body 10 to be added to the predetermined part on the car. The present invention makes connector positioning holes 11 on the two ends of the deflector body 10. Using the connector positioning holes 11, the positioning bolt 21 of the connecting component 20 can be secured, and an oblique rear wing 12 is placed on one side of the spoiler body 10.

A support base 30 is placed on the predetermined part (such as the middle section) on the bottom of the spoiler body 10.

A luminous body 40 is placed on the predetermined part on the external part of the spoiler body 10. The luminous body 40 can be electroluminescent, an LED, cold cathode fluorescent tube etc. The assembling of the luminous body 40 can be of several different types, and it is described within the figures and herein.

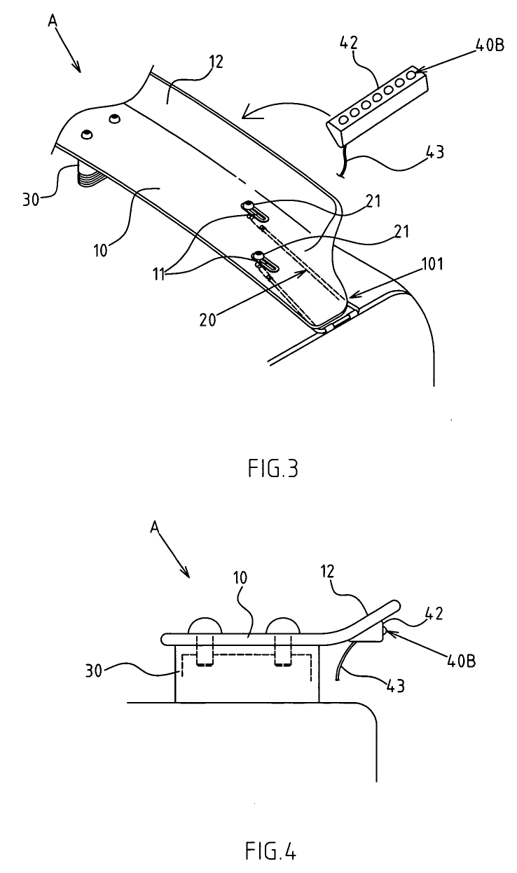

The luminous body 40, as shown in FIG. 2, is electroluminescent. The luminous body 40 is placed on the bottom or top surface of the rear wing 12 of the spoiler body 10. The method of attachment is not limited, but the methods include adhesive, locked, or hooked. One side of the luminous body 40 is connected to the power outlet in the car through an electric circuit. The luminous body 40B, as shown in FIG. 3, 4, is placed on the bottom or top surface of the rear wing 12 of the spoiler body 10, and the luminous body 40B of the present embodiment can be an LED, using a casing 42 to integrate several luminous body 40B into one piece. The luminous body 40B is connected to the power outlet in the car through an electric circuit 43.

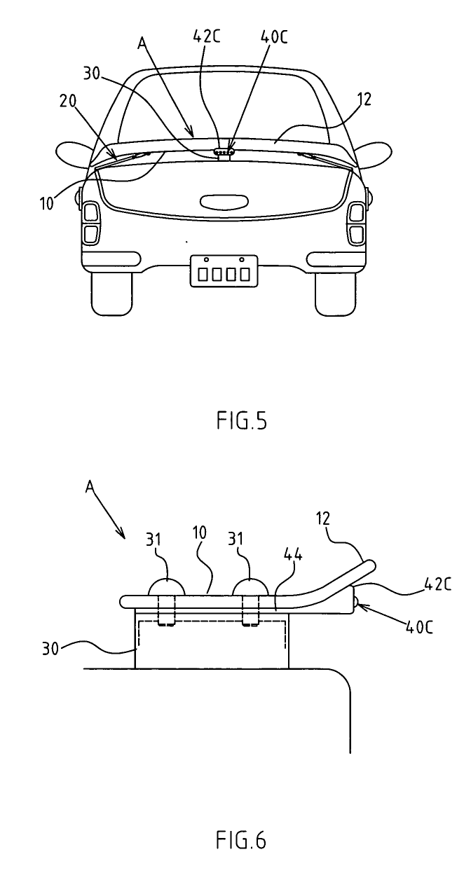

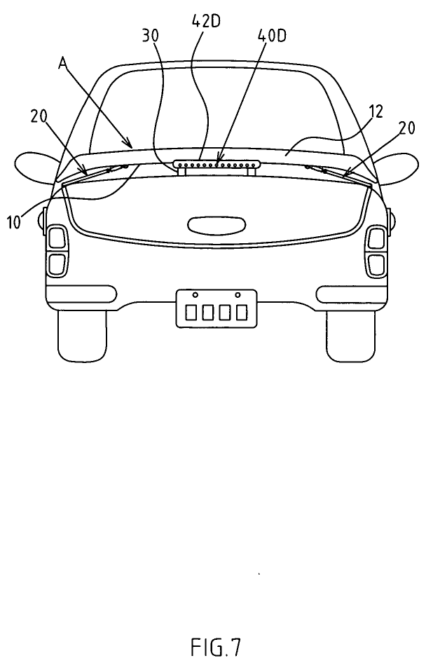

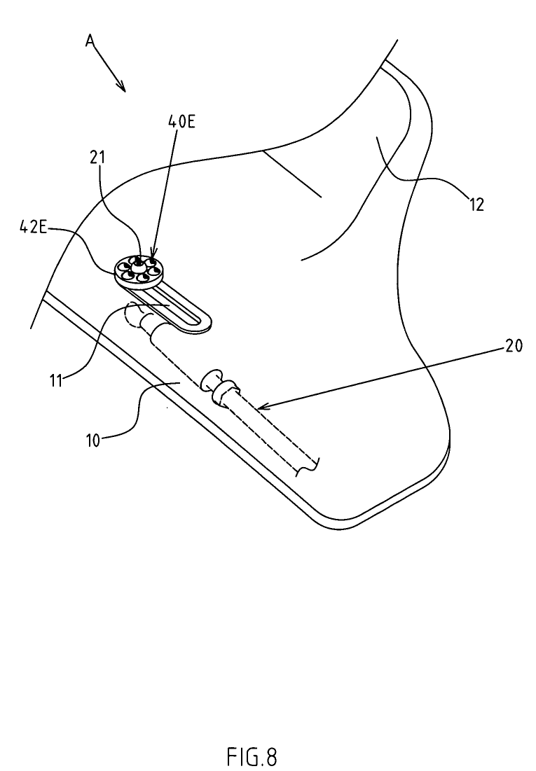

As shown in FIGS. 5, 6, the luminous body 40C is placed between the spoiler body 10 and the support base 30. The luminous body 40C of the present embodiment has a protruding edge 44 formed on one side of the casing 42C, and it can be placed between the spoiler body 10 and the support base 30. When the screw bolt 31 of the support base 30 is fixed, it locks the protruding edge 44 and positions the casing 42 and luminous body 40C. The luminous body 40D shown in FIG. 7 is a modified embodiment, and its casing 42D can form a structure that is set on top of two support bases 30.

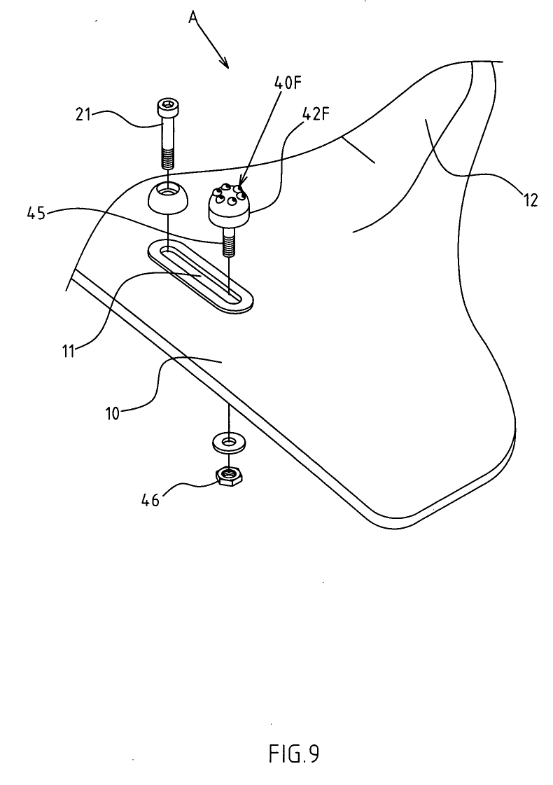

The luminous body 40E, as shown in FIG. 8, is placed on the connector positioning hole 11 of the spoiler body 10, and the casing 42E for the luminous body 40E can be a plate or button. The luminous body can be positioned by positioning bolt 21 of the connecting component 20 in the center. Moreover, the luminous body 40F shown in FIG. 9 has a screw 45 placed on the bottom of its casing 42F, and the screw 45 goes through the connector positioning hole 11 of the deflector body 10 to be positioned through the screw bolt 46.

I claim:

1. A spoiler accessory for a car, comprising:
a spoiler body, being a plate element with two ends, each of said two ends having a connecting part for attachment to a predetermined part on the car, said spoiler body having connector positioning holes on two ends thereof, said connector positioning holes using a positioning bolt for each connecting part to be secured, said spoiler body having an oblique rear wing placed on one side thereof.

2. The spoiler accessory defined in claim 1, further comprising:
a luminous body being electroluminescent, LED, or a cold cathode fluorescent tube.

3. The spoiler accessory defined in claim 2, wherein said luminous body is placed on a top or bottom surface of said spoiler body.

4. A spoiler accessory for a car, comprising:
a spoiler body, being a plate element with two ends, each of said two ends having connector positioning holes, each of said connector positioning holes securing said spoiler body using a positioning bolt, said spoiler body having an oblique rear wing placed on one side thereof;
at least one support base, being placed on a predetermined part at a bottom of said spoiler body; and
at least one luminous body, being placed on a predetermined part on an external part of said spoiler body.

5. The spoiler accessory defined in claim 4, further comprising:
a luminous body being electroluminescent, LED, or a cold cathode fluorescent tube etc.

6. The spoiler accessory defined in claim 5, wherein said luminous body is placed on a top surface or bottom surface of the rear wing.

7. The spoiler accessory defined in claim 5, wherein said luminous body can be placed between the spoiler body and support base.

8. The spoiler accessory defined in claim 5, wherein said luminous body is placed on the connector positioning hole of said spoiler body.
